(19) United States
(12) Patent Application Publication
(10) Pub. No.: US 2017/0067771 A1
(43) Pub. Date: Mar. 9, 2017

(54) SYSTEM AND METHOD FOR ACCURATE WEIGHT MEASUREMENT ON A WEIGH BELT

(71) Applicant: USC, LLC, Sabetha, KS (US)

(72) Inventors: Daniel Tramp, Sabetha, KS (US); Timothy A. Craft, Holton, KS (US)

(73) Assignee: USC, LLC, Sabetha, KS (US)

(21) Appl. No.: 15/226,469

(22) Filed: Aug. 2, 2016

Related U.S. Application Data
(60) Provisional application No. 62/216,205, filed on Sep. 9, 2015.

(51) Int. Cl. G01G 11/04; G01G 23/01

(52) U.S. Cl. CPC G01G 11/04; G01G 23/01

(57) ABSTRACT

A system and method for more accurately weighing a product on a continuous weigh belt. The system includes a processing element for determining a flow rate and a total weight of the product at a plurality of points on the weigh belt. A length of the weigh belt between product entrance and exit points is divided into discrete measurement units, or “buckets.” The weight of product in each bucket is determined. The total weight of product that has reached the entrance, exit, and one or more intermediate points on the weigh belt is determined by adding the weight of product attributed to all of the buckets that have reached each point. The flow rate of the product at these points is determined based on the weight of the product attributed to the particular bucket at each point and the speed of the weigh belt.

### CROSS-REFERENCE TO RELATED APPLICATION

This application claims the benefit of Provisional Application Ser. No. 62/216,205, filed Sep. 9, 2015, which is incorporated herein by reference in its entirety.

### FIELD

The present invention relates to systems and methods for weighing product on a weigh belt or other conveying system.

### BACKGROUND

Weigh belt systems are commonly used to weigh products such as bulk materials as they are conveyed to a packaging, transport, or other output process or area. An exemplary weigh belt system configured to weigh a product comprises a frame, a drive roller, a non-drive roller, a motor, a continuous weigh belt, an encoder, a gate, and a load cell. The drive roller is mounted to a first end of the frame, and the non-drive roller is mounted to an opposite second end. The motor is also mounted to the first end and is configured to turn the drive roller. The weigh belt extends around and between the drive and non-drive rollers and is configured to turn with the drive roller. The encoder is configured to pulse with the turning of the non-drive roller so as to provide an indication of the speed of the weigh belt. The gate is positioned over the weigh belt and configured to deliver the product onto the weigh belt. The load cell is configured to determine a weight of the product on the weigh belt.

In operation, the product is delivered to the weigh belt via the gate, and then travels down the weigh belt until it exits the system. As the product travels on the weigh belt, a flow rate of the product is calculated based on the weight of the product on the weigh belt, as determined by the load cell, and the speed of the weigh belt, as determined by the encoder. Furthermore, once the flow rate is known, a total weight of the product delivered to and exiting the weigh belt is calculated by multiplying the flow rate by the run-time.

One problem with this method of determining the flow rate and the total weight of the product is that it averages the weight of the product on the weigh belt over the entirety of the weigh belt, and therefore the flow rate value and the total weight value are never accurately representative of any particular point on the weigh belt (e.g., the point at which the product enters or exits the weigh belt). For example, as the product is initially delivered to the weigh belt, the total weight value begins increasing even though none of the product has yet exited the weigh belt (i.e., at that time, the total weight value is indicative of a point in time that is behind the initial delivery of the product). A similar misrepresentation occurs once the last of the product has been delivered to the weigh belt but has not yet exited the weigh belt (i.e., at that time, the total weight value is indicative of a point in time that is ahead of the final delivery of the product). Thus, at different points in the process, the flow rate and the total weight values are inaccurate.

This background discussion is intended to provide information related to the present invention which is not necessarily prior art.

### SUMMARY

Embodiments of the present invention solve the above-described and other problems and limitations by providing a system and method for more accurately weighing product on a weigh belt. In an embodiment of the present invention, a weigh belt system may broadly comprise an elongated, continuous, driven weigh belt oriented to receive product at an entrance point, and to transport the received product to an exit point. Such weight belt structure may include a frame; a drive roller mounted to one end of the frame; a non-drive roller mounted to the other end of the frame; and a continuous weigh belt extending around and between the drive and non-drive rollers and configured to be moved by the drive roller to transport the product to the exit point. The overall system further has an encoder or other pulse-generating element for generating a plurality of pulses associated with the movement of the weigh belt; a gate or other product-delivering element positioned over the weigh belt for delivering the product onto the weigh belt at an entrance point; a load cell or other weight-determining element for determining a weight of the product on the weigh belt; and a processing element for determining a flow rate of the product and a total weight of the product at a plurality of points on the weigh belt. The processing element may be configured to perform the following actions. The speed of the weigh belt may be determined based on the pulses generated by the pulse-generating element. The length of the weigh belt between the entrance and exit points may be divided into a plurality of “buckets” (i.e., discrete measurement units), wherein the buckets form a line of buckets between the entrance and exit points. The total weight of the product that has reached the entrance point, the exit point, and at least one intermediate point on the weigh belt may be determined and reported, and the flow rate of the product at the entrance point, the exit point, and the at least one intermediate point may be determined and reported.

Various implementations of the foregoing embodiment may include any one or more of the following additional features. The processing element may be configured to determine the total weight of the product that has reached a particular point as follows. The weight and the flow rate of the product may be determined for each bucket. More specifically, when a particular bucket is located at the entrance point and receives the product delivered by the product-delivering element, the processing element may compare the prior weight of the product on the weigh belt as determined by the weight-delivering element to the current weight of the product on the weigh belt, and attribute the difference in weight to the particular bucket located at the entrance point. As the weigh belt transports the product to the exit point, each bucket advances until the bucket reaches the exit point and then returns to the beginning of the line of buckets. Between the particular bucket reaching the exit point and being returned to the beginning of the line of buckets, the processing element attributes a weight of zero to the particular bucket. The total weight of the product that has reached the entrance point, the exit point, and the at least one intermediate point may be determined by adding the weight of the product attributed to all of the buckets that have reached each such point. The processing element may be further configured to determine the flow rate of the product at the entrance point, the exit point, and the at least one intermediate point based on the weight of the product attributed to the particular bucket at that point and the speed of the weigh belt.

The processing element may be further configured to attribute a weight of zero to a particular bucket if the determined weight of the product associated with the particular bucket is within a pre-established range of values. The processing element may be further configured to control the opening and closing of the product-delivering element so as to control delivery of the product onto the weigh belt. Relatedly, the processing element may close the product-delivering element, run the motor to turn the weigh belt until each bucket in the line of buckets has passed the exit point, and then attribute a weight of zero to all of the buckets. The processing element may be further configured to address “splashing” of initially deliver product across multiple buckets by attributing the weight of the initial delivery of the product onto the weigh belt to two or more adjacent buckets. The processing element may be further configured to calibrate itself by sending a known weight of the product through the system, determining the total weight of the product sent through the system, comparing the determined weight to the known weight, compensating for a difference between the determined and known weights by adjusting the number of buckets, and thereafter using the adjusted number of buckets in its calculations.

It will be understood that the forgoing embodiment and implementations may be characterized in method terms based on the actions performed by the processing element.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is an isometric view of a weigh belt system constructed in accordance with an embodiment of the present invention for weighing a product;

FIG. 2 is an elevation view of the system of FIG. 1 showing a division of a weigh belt component into a plurality of discrete measurement units;

FIG. 3 is an elevation view of the system of FIG. 2 shown at a first stage of operation;

FIG. 4 is an elevation view of the system of FIG. 2 shown at a second stage of operation;

FIG. 5 is an elevation view of the system of FIG. 2 shown at a third stage of operation;

FIG. 6 is an elevation view of the system of FIG. 2 shown at a fourth stage of operation;

FIG. 7 is an elevation view of the system of FIG. 2 shown at a fifth stage of operation;

FIG. 8 is an elevation view of the system of FIG. 2 shown at a sixth stage of operation; and

FIG. 9 is a flowchart of steps involved in the operation of the system of FIG. 2.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

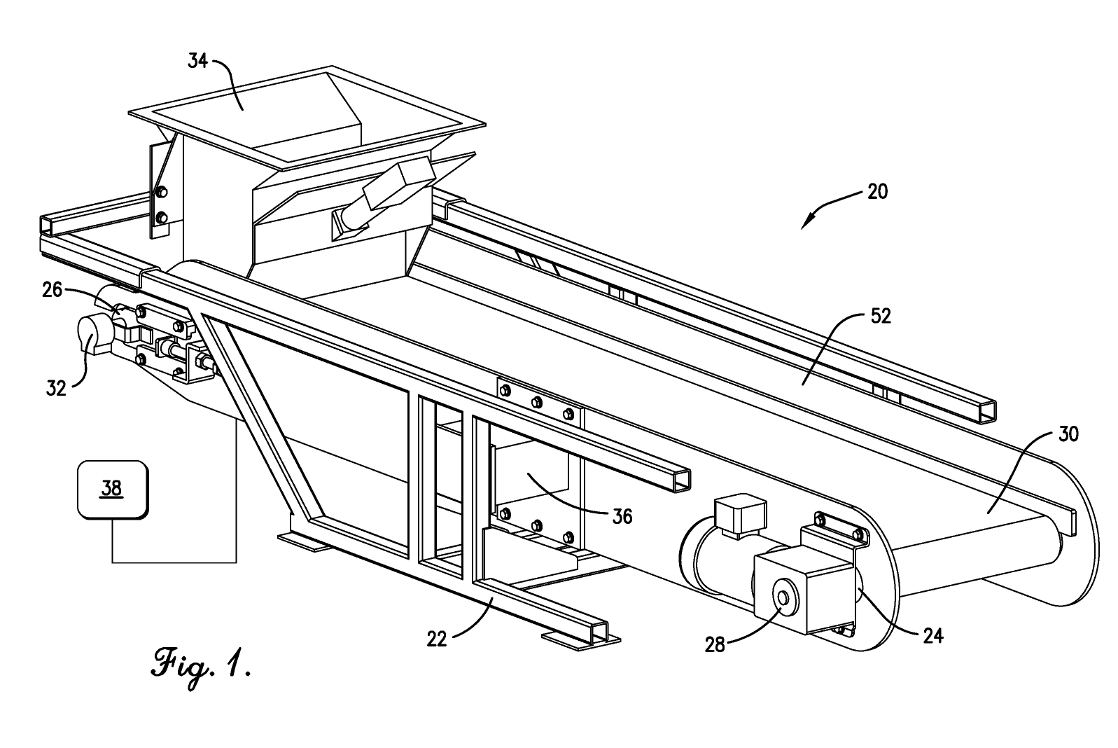

Broadly characterized, the present invention provides a system and method for more accurately weighing product on a weigh belt. Referring to FIG. 1, an embodiment of the weigh belt system 20 of the present invention is shown comprising a frame 22, a drive roller 24, a non-drive roller 26, a motor 28, a continuous weigh belt 30, an encoder or other pulse-generating element 32, a gate or other product-delivering element 34, a load cell or other weight-determining element 36, and a processing element 38. The frame 22 may include a first end 44 and a second end 46, and may be configured to support other components of the system 20, including supporting the load cell 36 in a manner that minimizes vibrational disturbance. The drive roller 24 may be mounted to the first end 44 of the frame 22, and the non-drive roller 26 may be mounted to the second end 46. The motor 28 may also mounted to the first end 44 of the frame, and may be configured to turn the drive roller 24. The continuous weigh belt 30 may extend around and between the drive and non-drive rollers 24, 26 and may be configured to turn with the drive roller 24. The encoder 32 may be configured to generate pulses based on the rotation of the non-drive roller 26, which may reflect the turning of the weigh belt 30, so as to provide an indication of the position and speed of the weigh belt 30. The encoder 32 may be an electronic encoder such as an electronic pulse generator. The gate 34 may be positioned over an area of the weigh belt 30, and may be configured to deliver the product onto the weigh belt 30 at an entrance point. The gate 34 may also be configured to report its state (i.e., open or closed), and to allow the processing element 38 or a user to control its state. The load cell 36 may be configured to determine a weight of the product on the weigh belt 30. In particular, the load cell 36 may subtract the extraneous weight of the weigh belt 30 and any other components of the system 20 so as to determine the weight of the product on the weigh belt 30.

The processing element 38 may be any suitable electronic device, such as a programmable logic controller, configured to receive the pulses generated by the encoder 32, to receive information regarding and to control the state of the gate 34, and to determine the flow rate and the total weight of the product on the weigh belt 30. The functionality of the processing element 38 is described in detail below.

The system 10 may further include a cradling component 52 configured to receive and retain the product on and generally in the center of the weigh belt 30. The cradling component 52 may take the form of side-walls associated with the weigh belt 30 or side walls associated with the frame 22. The system 10 may further include an outer shell (not shown) configured to protect the weigh belt 30 and the load cell 36 against disturbance.

Various components of the system 20 may communicate internally and/or externally through hardware inputs and outputs as well as standard communication protocols (e.g., EthernetIP, Modbus TCP/IP). Information communicated externally may include flow rates at the entrance, intermediate, and exit points; total product weights at the entrance, intermediate, and exit points; a state of the weigh belt 30 (i.e., moving or stopped); whether the weight on the weigh belt 30 has been zeroed; a state of the gate 34 (i.e., open or closed); and/or control of the operation of the gate 34.

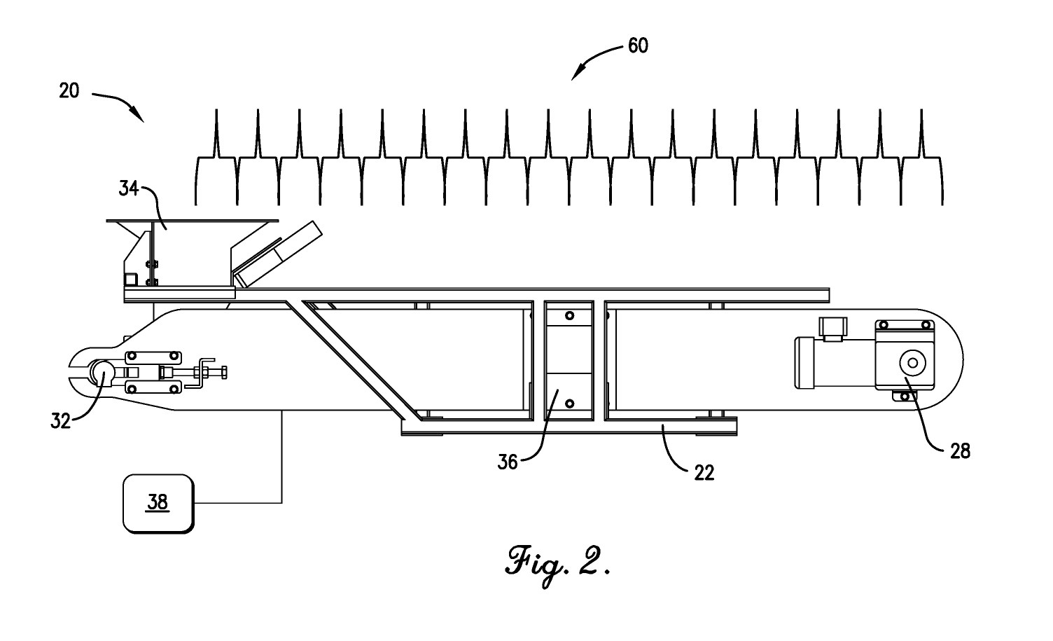

In operation, the weigh belt system 20 may be configured to determine a total amount of product that has entered and exited the system 20, and to determine a flow rate of product through the system 20. Referring also to FIG. 2, product may be delivered by the gate 34 to the entrance point on the weigh belt 30, and then travel on the weigh belt 30 until it reaches an exit point and leaves the weigh belt 30 and the system 20. The load cell 36 may determine the total weight of the weigh belt 30, and then communicate the determined total weight to the processing element 38. The processing element 38 may then subtract the known weight of the weigh belt 30 to arrive at the total weight of product on the weigh belt 30. The encoder 32 may generate pulses based on the turning of the non-drive roller 26, which reflects the movement of the weigh belt 30, and then communicates the pulses to the processing element 38. The processing element 38 may then determine, based on the encoder's pulses, the rotational speed of the non-drive roller 26, and may further determine, based on the rotational speed and a known diameter of the non-drive roller 26, the speed of the weigh belt 30.

The processing element 38 may divide the portion of the weigh belt 30 between the entrance point and the exit point (i.e., the portion on which product may be located) into a plurality of “buckets” 60 (i.e., discrete measurement units). The size of each bucket 60 may be based on the pulses generated by the encoder 32, wherein each bucket 60 may represent a discrete space defined by the distance travelled by the weigh belt 30 between the rising edges of consecutive pulses. The plurality of buckets 60 may form a line of buckets 60 extending between the product entrance and exit points on the weigh belt 30. Each bucket 60 may contain a bucket weight of product. In particular, the bucket weight of each bucket 60 may be determined by the amount of product that has entered the weigh belt 30 divided by the total number of buckets 60 that have “pulsed” since the last weight determination. The bucket weight value of each bucket 60 may be associated with that bucket 60 until it has exited the weigh belt 30. Upon exiting the weigh belt 30, each bucket 60 may return to the entrance point and have a new bucket weight value assigned to it.

During each scan by the processing element 38, the system 20 may determine whether the buckets 60 have advanced (i.e., whether the weigh belt 30 is moving). As the buckets 60 advance, the plurality of bucket weights which comprise the total weight of product on the belt may be updated. The processing element 38 may compare a last known weight on the weigh belt 30 to a current weight on the weigh belt 30 to determine a change in weight attributable to product that entered the gate 34 and was deposited in a bucket 60. Once a bucket 60 reaches the exit point on the weigh belt 30 and can no longer advance, it may be returned to the beginning of the line of buckets 60. Thus, if the weigh belt 30 is moving, the processing element 38 may update bucket weights by determining the total weight of all buckets 60 that returned to the beginning of the line of buckets 60 between scans. Furthermore, based on the change in weight and the total weight on the weigh belt 30, the processing element 38 may determine the amount of weight that has entered the weigh belt 30 during the scan. The processing element 38 may divide the amount of weight that has entered the weigh belt 30 during the scan by the total number of buckets 60 that have returned to the beginning of the line of buckets 60, and assign this bucket weight to each of the returned buckets 60. This allows for more accurate weight determination on the weigh belt 30 at any speed.

Thus, the processing element 38 may determine the total weight of product that has passed any particular point on the weigh belt 30 (e.g., the entrance, intermediate, or exit points) by adding the total bucket weights between the end of the line of buckets 60 and the particular point on the weigh belt 30. For example, the processing element 38 may determine the total weight of product that has exited the weigh belt 30 by adding the bucket weights of all of the buckets 60 as they return to the beginning of the line of buckets 60.

The processing element 38 may also calculate the flow rate of product that has exited the weigh belt 30 based on the total amount that has exited over a particular period of time. Similarly, the processing element 38 may calculate the flow rate of product that has passed a particular point on the weigh belt 30 by determining the total weight of product at that point over a particular period of time. Additionally, because the system 20 more accurately calculates flow rates, the system 20 may be configured to work with a gate that can automatically adjust to achieve a desired flow rate.

An exemplary implementation of this process is shown in FIGS. 2-8. More specifically, FIG. 2 depicts the system 20 before any product has been delivered via gate 34. In this example, the length of the weigh belt 30 between the entrance and exit points has been divided into eighteen buckets 60.

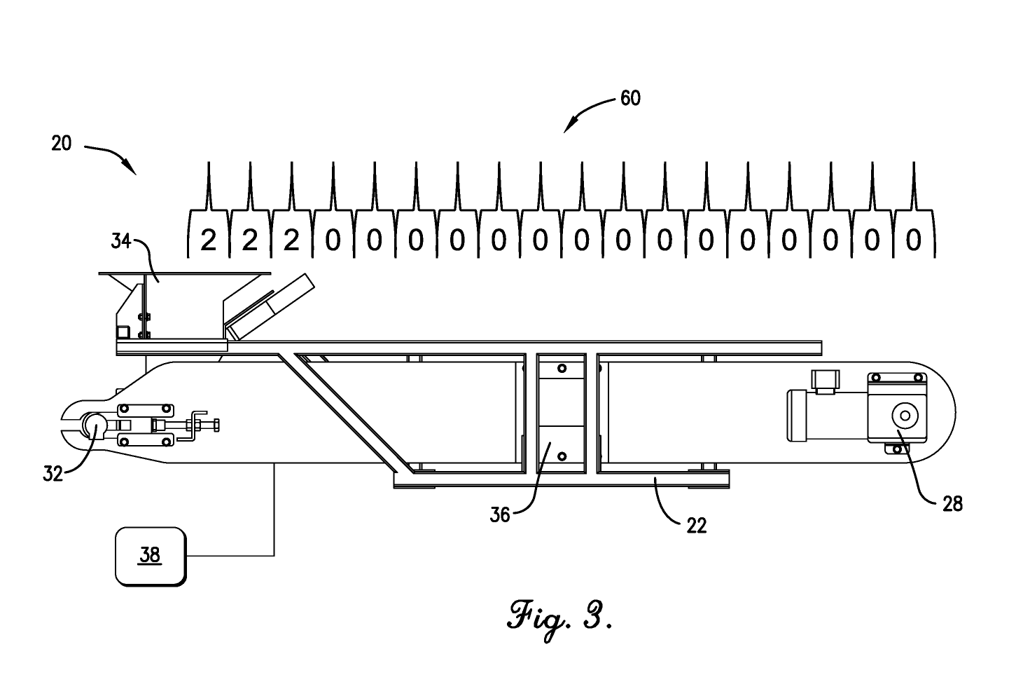

FIG. 3 depicts the system 20 one second after the delivery of product began. The encoder 32 indicates that the weigh belt 30 is moving at three buckets per second, and the load cell 36 indicates that six pounds of product are currently on the weigh belt 30. The processing element 38 has calculated that the total weight of product that has passed the entrance point is six pounds, while the total weights that have passed the intermediate and exit points are zero pounds (because no product has yet reached those points). The processing element 38 has also calculated that the flow rate of product at the entrance point is six pounds per second, while the flow rates at the intermediate and exit points are zero pounds per second (because no product has yet reached those points).

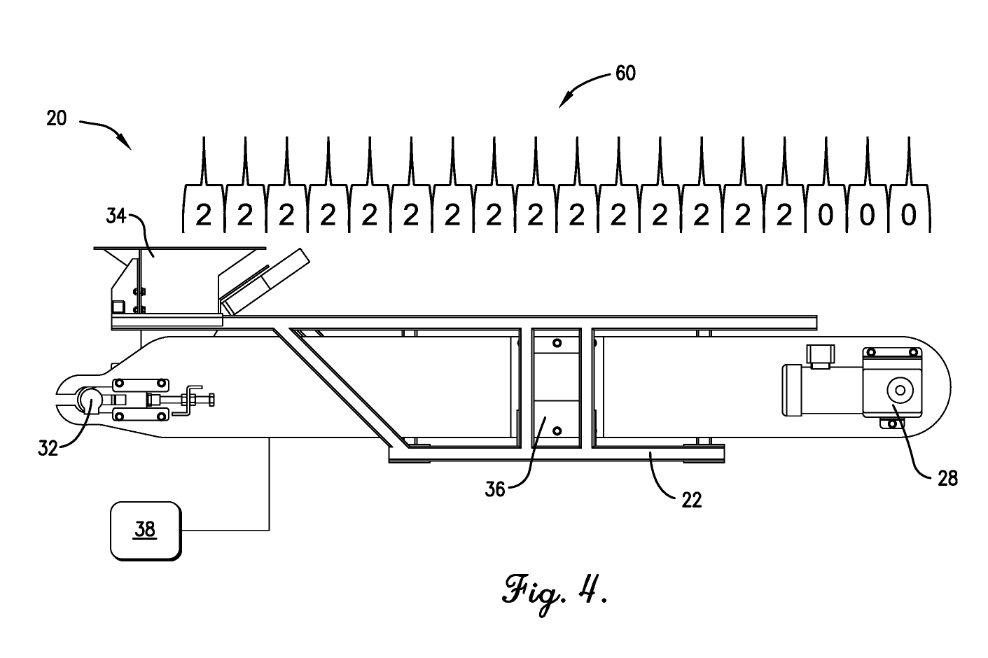

FIG. 4 depicts the system five seconds after the delivery of product began. The encoder 32 indicates that the weigh belt 30 is still moving at three buckets per second, and the load cell 36 indicates that thirty pounds of product are currently on the weigh belt 30. The processing element 38 has calculated that the total weight of product that has passed the entrance point is thirty pounds, the total weight that has passed the intermediate point is twelve pounds, and the total weight that has passed the exit point is zero pounds. The processing element 38 has also calculated that the flow rate of product at the entrance point is six pounds per second, the flow rate at the intermediate point is six pounds per second, and the flow rate at the exit point is zero pounds per second.

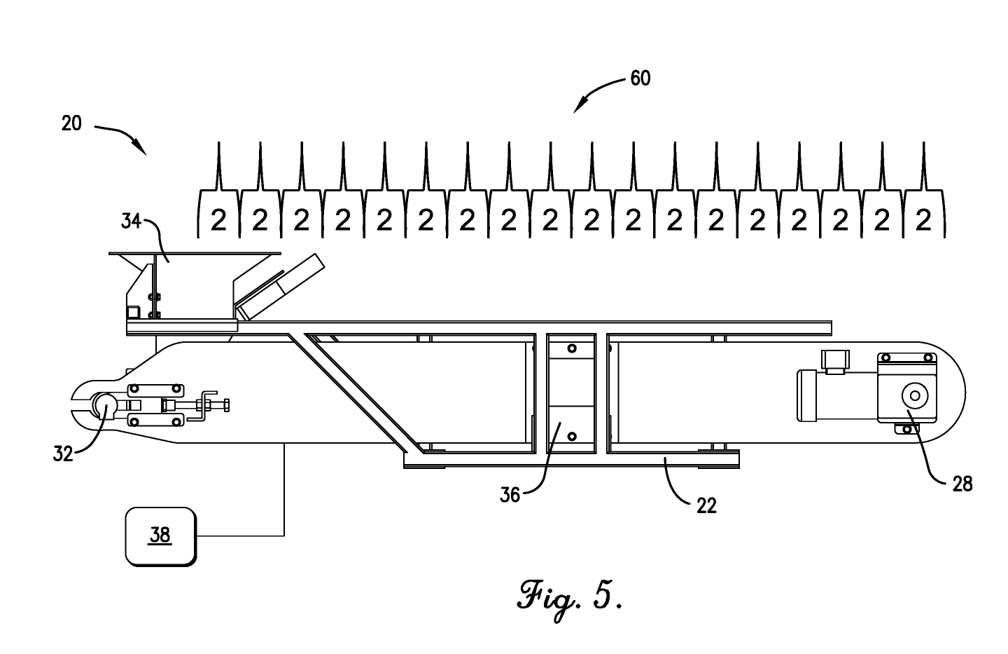

FIG. 5 depicts the system twenty seconds after the delivery of product began. The encoder 32 indicates that the weigh belt 30 is still moving at three buckets per second, and the load cell 36 indicates that thirty-six pounds of product are currently on the weigh belt 30 (i.e., two pounds per bucket). The processing element 38 has calculated that the total weight of product that has passed the entrance point is one hundred fifty pounds, the total weight that has passed the intermediate point is one hundred thirty-two pounds, and the total weight that has passed the exit point is one hundred fourteen pounds. The processing element 38 has also calculated that the flow rates of product at the entrance, intermediate, and exit points are all six pounds per second.

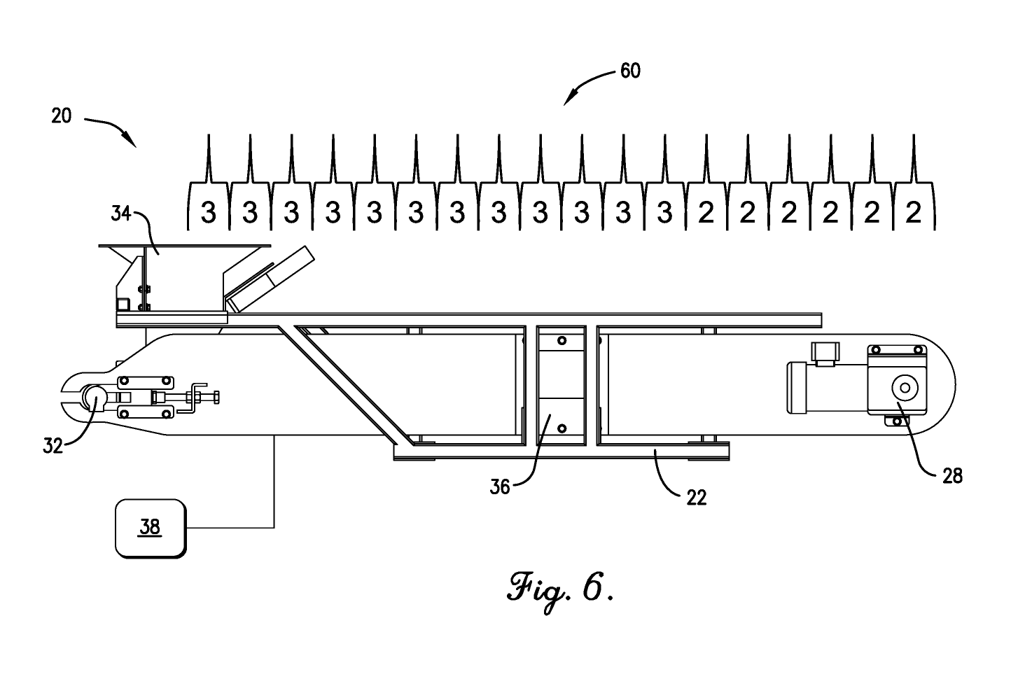

FIG. 6 depicts the system twenty-four seconds after the delivery of product began, and the flow rate has increased from six to nine pounds per second. The encoder 32 indicates that the weigh belt 30 is still moving at three buckets per second, and the load cell 36 indicates that forty-eight pounds of product are currently on the weigh belt 30. The processing element 38 has calculated that the total weight of product that has passed the entrance point is one hundred eighty-six pounds, the total weight that has passed the intermediate point is one hundred fifty-nine pounds, and the total weight that has passed the exit point is one hundred thirty-eight pounds. The processing element 38 has also calculated that the flow rates at the entrance and intermediate point have increased to nine pounds per second, while the flow rate at the exit point is still six pounds per second.

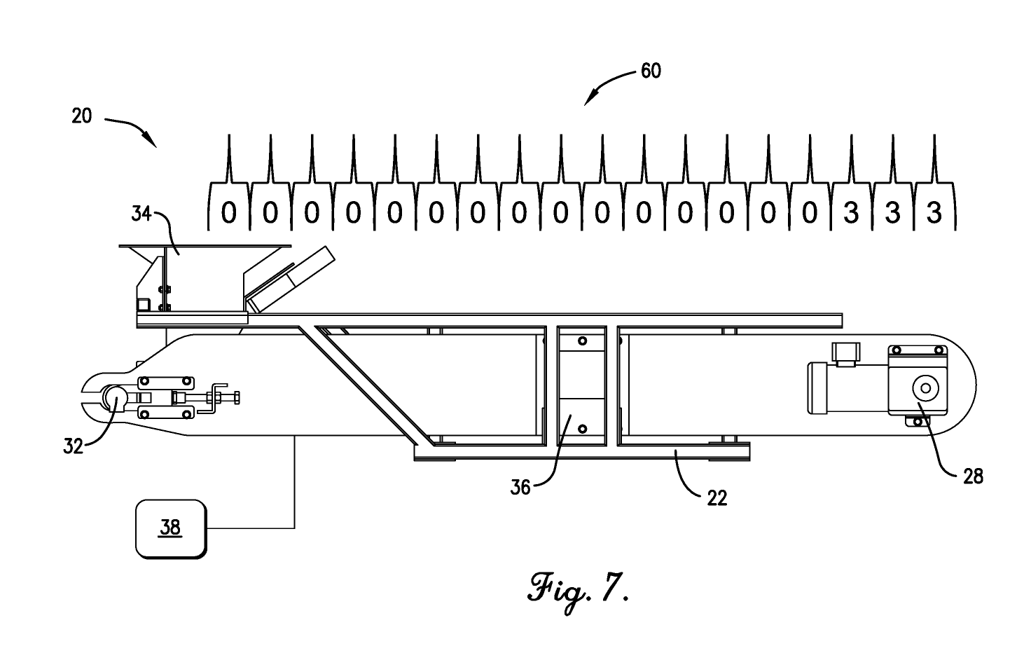

FIG. 7 depicts the system after the delivery of product stopped, and the flow rate has decreased to zero pounds per second. The encoder 32 indicates that the weigh belt 30 is still moving at three buckets per second, and the load cell 36 indicates that nine pounds of product are currently on the weigh belt 30. The processing element 38 has calculated that the total weights of product that have passed the entrance and intermediate points are both three hundred twenty-one pounds, while the total weight that has passed the exit point is one three hundred twelve pounds. The processing element 38 has also calculated that the flow rates at the entrance and intermediate point have decreased to zero pounds per second, while the flow rate at the exit point is still nine pounds per second.

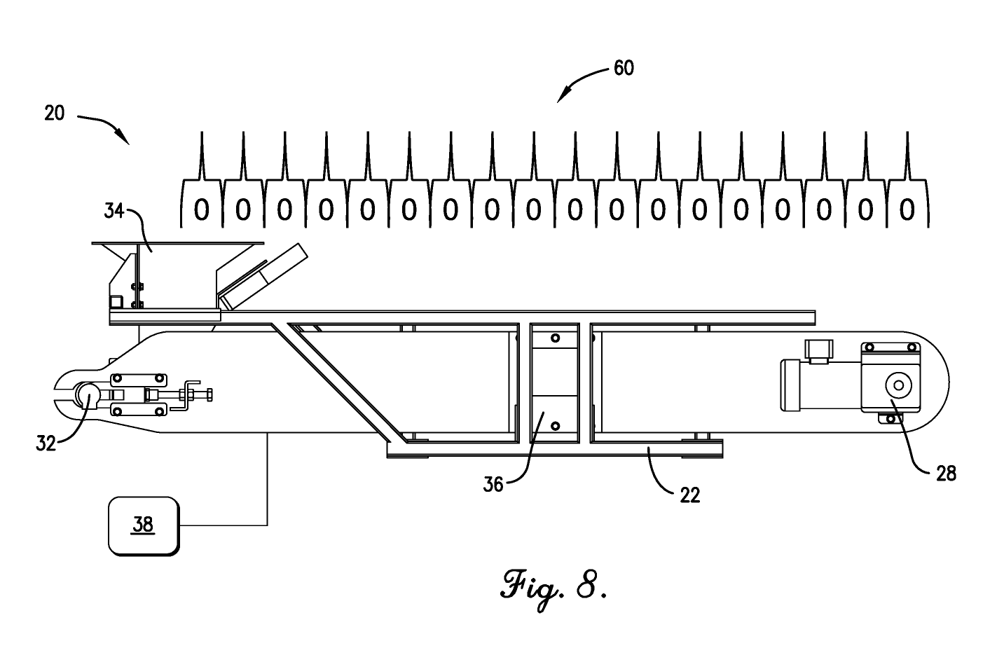

FIG. 8 depicts the system 20 after all product has passed the exit point.

Although total weights and flow rates for only the entrance, intermediate, and exit points were described in this example, the processing element 38 may be configured to calculate total weights and flow rates for substantially any point between the entrance and exit points.

The processing element 38 may be further configured to automatically assign a weight of zero to all of the buckets 60 if they are within a pre-established tolerance of the zero point on the scale. This eliminates any residual assigned weight in the buckets 60 that may result from the processing element's 38 method of dividing the total weight among the buckets 60 in relation to the resolution of the load cell 34.

The processing element 38 may also be configured to control the opening and closing of the gate 34. This allows for determining the weights of batches of product on the weigh belt 30. It also allows for automatically zeroing the load cell 36. More specifically, if the gate 34 is closed, the processing element 38 may run the weigh belt 30 for a period of time sufficient for all of the buckets 60 to move to the end of the line of buckets 60 (i.e., the exit point on the weigh belt 30) at least once, and then zero the load cell's scale. Once the load cell's scale is zeroed, the bucket weight values assigned to the buckets 60 may be cleared. The processing element may then cause the gate 34 to reopen.

The processing element may also be configured to handle “splashing” of the product. More specifically, the first amount of product delivered to the weigh belt 30 may “splash” and spread across two or more buckets 60. Product subsequently delivered to the weigh belt 30 may be restrained from such splashing by adjacent product already on the weigh belt 30. Splashing may be exacerbated by the gate's design or by its vertical positioning relative to the weigh belt 30. The processing element 38 may compensate for such splashing by associating the initial weight of the product over a pre-established number of buckets 60 rather than only the number of buckets 60 that have returned to the beginning of the line of buckets during the current scan. This may be accomplished by updating the number of buckets 60 at the beginning of the line of buckets 60 based on the splash total whenever the weight of the weigh belt 30 moves from being within the zero tolerance range to being above the zero tolerance range.

The processing element 38 may also be configured to calibrate its calculations by sending a known total weight of product through the system 20, comparing the determined total weight of product to the actual known weight of product and adjusting the total number of buckets 60 to compensate for any difference. The adjusted number of buckets may then be used in subsequent calculations by the processing element 38.

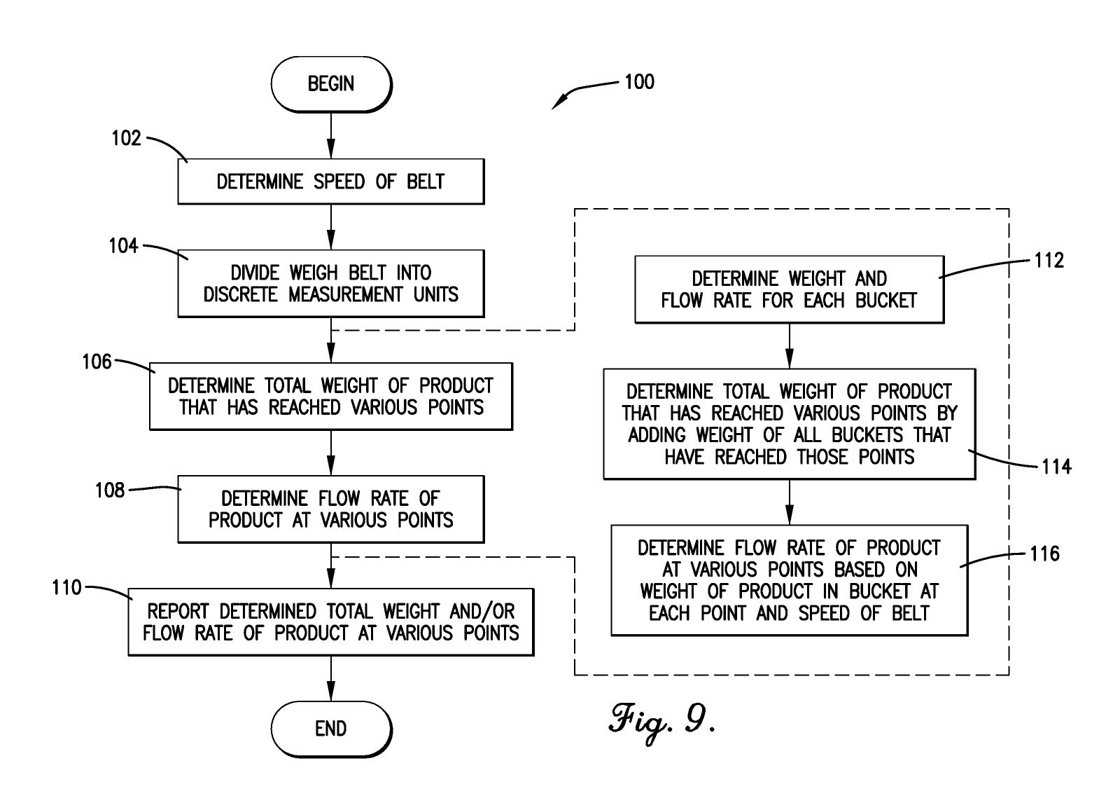

Referring to FIG. 9, exemplary operation of the system 20 may be broadly characterized as a method 100 comprising the following actions performed by the electronic processing element 38. The speed of the weigh belt 30 may be determined based on the pulses generated by the encoder 32, as shown in step 102. The length of the weigh belt 30 between the entrance and exit points may be divided into the plurality of buckets 60, as shown in step 104, wherein the plurality of buckets form a line of buckets 60 between the entrance and exit points. The size of each bucket 60 may be based on a time period between consecutive pulses generated by the encoder 32. The total weight of the product that has reached the entrance point, the exit point, and at least one intermediate point on the weigh belt 30 may be determined, as shown in step 106. The flow rate of the product at the entrance point, the exit point, and the at least one intermediate point may be determined, as set forth in step 108. The total weight and/or the flow rate of the product at the entrance point, the exit point, and the at least one intermediate point may be reported, as shown in step 110.

In one implementation, steps 106 and/or 108 may be accomplished by the processing element 38 as follows. The weight and the flow rate of the product may be determined for each bucket 60, as shown in step 112. More specifically, when a particular bucket is located at the entrance point and receives the product delivered by the gate 34, the processing element 38 may compare the prior weight of the product on the weigh belt 30 as determined by the load cell 36 to the current weight of the product on the weigh belt 30, and attribute the difference in weight to the particular bucket 60 located at the entrance point. As the weigh belt 30 transports the product to the exit point, each bucket 60 advances until the bucket 60 reaches the exit point and then returns to the beginning of the line. Between the particular bucket reaching the exit point and being returned to the beginning of the line of buckets, the processing element 38 attributes a weight of zero to the particular bucket. The total weight of the product that has reached the entrance point, the exit point, and the at least one intermediate point may be determined by adding the weight of the product attributed to all of the buckets 60 that have reached each such point, as shown in step 114. The flow rate of the product at the entrance point, the exit point, and the at least one intermediate point may be determined based on the weight of the product attributed to the particular bucket at that point and the speed of the weigh belt, as shown in step 116.

In various implementation, the processing element 38 may be further configured to perform any one or more of the following actions. A weight of zero may be attributed to a particular bucket if the determined weight of the product associated with the particular discrete measurement unit is within a pre-established range of values. The opening and closing of the gate 34 may be controlled so as to control delivery of the product onto the weigh belt 30. In one implementation, the gate 34 may be closed, the motor 32 may be run to turn the weigh belt 30 until each bucket 60 in the line of buckets 60 has passed the exit point, and then a weight of zero may be attributed to all of the buckets 60. To address splashing, the weight of an initial delivery of the product onto the weigh belt 30 may be attributed to two or more adjacent buckets 60. The processing element 38 may be further configured to calibrate itself by sending a known weight of the product through the system 20, determining the total weight of the product sent through the system 20, comparing the determined weight to the known weight, compensating for a difference between the determined and known weights by adjusting the number of buckets 60, and thereafter using the adjusted number of buckets 60 in its calculations.

The present invention provides several advantages over prior art methods. For example, the present invention allows for more accurately calculating a flow rate and a total weight of product that has passed any point on a belt, such as entrance, intermediate, and exit points. This advantage may be particularly useful when the belt has been stopped, with some portion of the product still on it, at the beginning or end of a run when the product does not cover the entirety of the belt, and when the product flow is inconsistent. Furthermore, the present invention eliminates calibration concerns when the product flow curves at the beginning and end of a run are different, which increases overall accuracy. Additionally, the present invention allows for more accurately determining batch weights of the product.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A weigh belt system for weighing a product, the system comprising:
an elongated, continuous, driven weigh belt oriented to receive product at an entrance point, and to transport the received product to an exit point;
a pulse-generating element configured to generate a plurality of pulses associated with the movement of the weigh belt;
a weight-determining element configured to determine a weight of the product on the weigh belt; and
a processing element configured to determine a flow rate of the product and a total weight of the product at a plurality of points on the weigh belt by performing the following actions
determining a speed of the weigh belt based on the plurality of pulses generated by the pulse-generating element,
dividing a length of the weigh belt between the entrance and exit points into a plurality of discrete measurement units, wherein the plurality of discrete measurement units form a line of discrete measurement units between the entrance and exit points,
determining the total weight of the product that has reached the entrance point, the exit point, and at least one intermediate point on the weigh belt,
determining the flow rate of the product at the entrance point, the exit point, and the at least one intermediate point, and
reporting the total weight and the flow rate of the product at the entrance point, the exit point, and the at least one intermediate point.

2. The weigh belt system as set forth in claim 1, wherein a size of each discrete measurement unit is based on a time period between consecutive pulses generated by the pulse-generating element.

3. The weigh belt system as set forth in claim 1, wherein the processing element is configured to determine the total weight and the flow rate of the product for each discrete measurement unit on the weigh belt.

4. The weigh belt system as set forth in claim 3, said system including a product-delivering element positioned adjacent the weigh belt and configured to deliver said product onto the weigh belt at said entrance point, wherein when a particular discrete measurement unit is located at the entrance point and receives the product delivered by the product-delivering element, the processing element compares the prior weight of the product on the weigh belt as determined by the weight-determining element to the current weight of the product on the weigh belt as determined by the weight determining element, and attributes the difference in the weight of the product to the particular discrete measurement unit located at the entrance point.

5. The weigh belt system as set forth in claim 4, wherein as the weigh belt transports the product to the exit point, each discrete measurement unit advances until the discrete measurement unit reaches the exit point and then returns to a beginning of the line of discrete measurement units.

6. The weigh belt system as set forth in claim 5, wherein between the particular discrete measurement unit reaching the exit point and being returned to the beginning of the line of discrete measurement units, the processing element attributes a weight of zero to the particular discrete measurement unit.

7. The weigh belt system as set forth in claim 4, wherein the processing element is configured to determine the total weight of the product that has reached the entrance point, the exit point, and the at least one intermediate point by adding the weight of the product attributed to all of the discrete measurement units that have reached each point.

8. The weigh belt system as set forth in claim 4, wherein the processing element is configured to determine the flow rate of the product at the entrance point, the exit point, and the at least one intermediate point based on the weight of the product attributed to the particular discrete measurement unit at that point and the speed of the weigh belt.

9. The weigh belt system as set forth in claim 4, wherein the processing element is configured to attribute a weight of zero to a particular discrete measurement unit if the determine weight of the product associated with the particular discrete measurement unit is within a pre-established range of values.

10. The weigh belt system as set forth in claim 1, said system including a product-delivering element positioned adjacent the weigh belt and configured to deliver said product onto the weigh belt at said entrance point, wherein the processing element is further configured to open and close the product-delivering element so as to control delivery of the product onto the weigh belt.

11. The weigh belt system as set forth in claim 10, wherein the processing element is further configured to close the product-delivery element, move the weigh belt until each discrete measurement unit in the line of discrete measurement units has passed the exit point, and then attribute a weight of zero to all of the discrete measurement units.

12. The weigh belt system as set forth in claim 1, wherein the processing element is further configured to attribute to two or more of the discrete measurement units a weight of an initial delivery of the product onto the weigh belt.

13. The weigh belt system as set forth in claim 1, said system including a product-delivering element positioned adjacent the weigh belt and configured to deliver said product onto the weigh belt at said entrance point, wherein the processing element is further configured to calibrate itself by sending a known weight of the product through the system, determining the total weight of the product sent through the system, comparing the determined weight to the known weight, compensating for a difference between the determined and known weights by adjusting the plurality of discrete measurement units, and thereafter using the adjusted plurality of discrete measurement units.

14. The weigh belt system of claim 1, said system including a frame having a first end and a second end, a drive roller mounted adjacent the first end of the frame, and a second non-drive roller mounted adjacent the second end of the frame, the weigh belt extending around and between the drive and non-drive rollers and configured to be moved by the drive roller to transport said product to said exit point,

15. A method of determining a flow rate of a product and a total weight of the product at a plurality of points on a weigh belt in a weigh belt system, the weigh belt system including
an elongated, continuous, driven weigh belt oriented to receive product at an entrance point, and to transport the received product to an exit point;
a pulse-generating element configured to generate a plurality of pulses associated with the movement of the weigh belt,
a weight-determining element configured to determine a weight of the product on the weigh belt, and
an electronic processing element,
the method comprising the following actions performed by the electronic processing element:
determining a speed of the weigh belt based on the plurality of pulses generated by the pulse-generating element;
dividing a length of the weigh belt between the entrance and exit points into a plurality of discrete measurement units, wherein the plurality of discrete measurement units form a line of discrete measurement units between the entrance and exit points;
determining the total weight of the product that has reached the entrance point, the exit point, and at least one intermediate point on the weigh belt;
determining the flow rate of the product at the entrance point, the exit point, and the at least one intermediate point; and
reporting the total weight and the flow rate of the product at the entrance point, the exit point, and the at least one intermediate point.

16. The method as set forth in claim 15, wherein a size of each discrete measurement unit is based on a time period between consecutive pulses generated by the pulse-generating element.

17. The method as set forth in claim 15, said system including a product-delivering element positioned adjacent the weigh belt and configured to deliver said product onto the weigh belt at said entrance point, wherein the processing element is configured to determine the total weight and the flow rate of the product for each discrete measurement unit on the weigh belt.

18. The method as set forth in claim 17, when a particular discrete measurement unit is located at the entrance point and receives the product delivered by the product-delivering element, the processing element compares the prior weight of the product on the weigh belt as determined by the weight-determining element to the current weight of the product on the weigh belt as determined by the weight-determining element, and attributes the difference in the weight of the product to the particular discrete measurement unit located at the entrance point.

19. The method as set forth in claim 18, wherein as the weigh belt transports the product to the exit point, each discrete measurement unit advances until the discrete measurement unit reaches the exit point and then returns to a beginning of the line of discrete measurement units.

20. The method as set forth in claim 19, wherein between the particular discrete measurement unit reaching the exit point and being returned to the beginning of the line of discrete measurement units, the processing element attributes a weight of zero to the particular discrete measurement unit.

21. The method as set forth in claim 20, wherein the processing element is configured to determine the total weight of the product that has reached the entrance point, the exit point, and the at least one intermediate point by adding the weight of the product attributed to all of the discrete measurement units that have reached each point.

22. The method as set forth in claim 21, wherein the processing element is configured to determine the flow rate of the product at the entrance point, the exit point, and the at least one intermediate point based on the weight of the product attributed to the particular discrete measurement unit at that point and the speed of the weigh belt.

23. The method as set forth in claim 18, wherein the processing element is configured to attribute a weight of zero to a particular discrete measurement unit if the determine weight of the product associated with the particular discrete measurement unit is within a pre-established range of values.

24. The method as set forth in claim 15, said system including a product-delivering element positioned adjacent the weigh belt and configured to deliver said product onto the weigh belt at said entrance point, wherein the processing element is further configured to open and close the product-delivering element so as to control delivery of the product onto the weigh belt.

25. The method as set forth in claim 24, wherein the processing element is further configured to close the product-delivering element, move the weigh belt until each discrete measurement unit in the line of discrete measurement units has passed the exit point, and then attribute a weight of zero to all of the discrete measurement units.

26. The weigh belt system as set forth in claim 15, wherein the processing element is further configured to attribute to two or more of the discrete measurement units a weight of an initial delivery of the product onto the weigh belt.

27. The weigh belt system as set forth in claim 15, wherein the processing element is further configured to calibrate itself by sending a known weight of the product through the system, determining the total weight of the product sent through the system, comparing the determined weight to the known weight, compensating for a difference between the determined and known weights by adjusting the plurality of discrete measurement units, and thereafter using the adjusted plurality of discrete measurement units.

28. A method of determining a flow rate of a product and a total weight of the product at a plurality of points on a weigh belt in a weigh belt system, the weigh belt system including
an elongated, continuous, driven weigh belt oriented to receive product at an entrance point, and to transport the received product to an exit point;
a pulse-generating element configured to generate a plurality of pulses associated with the movement of the weight belt,
a weight-determining element configured to determine a weight of the product on the weigh belt, and
an electronic processing element,
the method comprising the following actions performed by the electronic processing element:
determining a speed of the weigh belt based on the plurality of pulses generated by the pulse-generating element;
dividing a length of the weigh belt between the entrance and exit points into a plurality of discrete measurement units, wherein a size of each discrete measurement unit is based on a time period between consecutive pulses generated by the pulse-generating element, wherein the plurality of discrete measurement units form a line of discrete measurement units between the entrance and exit points, and wherein as the weigh belt transports the product to the exit point, each discrete measurement unit advances until the discrete measurement unit reaches the exit point and then returns to a beginning of the line of discrete measurement units;
determining a weight of the product for each discrete measurement unit on the weigh belt, wherein when a particular discrete measurement unit is located at the entrance point and receives the product, the processing element compares the prior weight of the product on the weigh belt as determined by the weight-determining element to the current weight of the product on the weigh belt as determined by the weight-determining element, and attributes the difference in the weight of the product to the particular discrete measurement unit located at the entrance point;
determining the total weight of the product that has reached the entrance point, the exit point, and at least one intermediate point on the weigh belt by adding the weight of the product attributed to all of the discrete measurement units that have reached each point;
determining the flow rate of the product at the entrance point, the exit point, and the at least one intermediate point based on the weight of the product attributed to the particular discrete measurement unit at that point and the speed of the weigh belt; and
reporting the total weight and the flow rate of the product at the entrance point, the exit point, and the at least one intermediate point.

29. The method of claim 28, said system including a drive roller, a non-drive roller, the weigh belt extending around and between the drive and non-drive rollers and configured to be moved by the drive roller to transport the product to an exit point, and a product-delivering element positioned over the weigh belt and configured to deliver the product onto the weigh belt at an entrance point,
